(19) United States
(12) Patent Application Publication
(10) Pub. No.: US 2011/0277719 A1
(43) Pub. Date: Nov. 17, 2011

(54) ROTARY INTAKE AND EXHAUST SYSTEM

(76) Inventor: Scott Snow, Commerce, MI (US)

(21) Appl. No.: 13/034,088

(22) Filed: Feb. 24, 2011

Related U.S. Application Data
(60) Provisional application No. 61/307,716, filed on Feb. 24, 2010.

(51) Int. Cl. F01L 7/00; F02B 37/00; F02M 25/07

(52) U.S. Cl. 123/190.4

(57) ABSTRACT

A rotary intake and exhaust system for an internal combustion piston engine that includes an engine having at least one cylinder and piston that define a combustion chamber. A crankshaft is coupled to the piston for moving the piston within the cylinder. A cylinder head is positioned to interface with the combustion chamber and includes a combustion chamber transfer port, and bifurcated intake and exhaust passages, called ports or tracts, formed therein. A driven rotatable shaft is positioned in the cylinder head to interact with the combustion chamber transfer port. The shaft includes intake and exhaust ports wherein rotation of the shaft transfers fluids and gases in and out of the combustion chamber.

### CROSS-REFERENCE TO RELATED APPLICATIONS

This application claims priority of U.S. Provisional Patent Application Ser. No. 61/307,716 filed Feb. 24, 2010, which is incorporated herein by reference.

### FIELD OF THE INVENTION

The invention relates to intake and exhaust systems for an internal combustion piston engine.

### BACKGROUND OF THE INVENTION

Generally, internal combustion engines of the piston type include a piston positioned within a cylinder and moves within the cylinder when coupled with a crankshaft to facilitate the combustion process. Generally, such piston engines include valve train components such as poppet valves, springs, rocker arms, rollers, push rods, lifters, cam lobes, and various other structures associated with a valve train. Such valve train systems may contribute to losses of power from the engine due to friction and resistance associated with the valve train components. Additionally, such valve train components may be subject to failure such as when a collision or impact between the valve train and the piston occurs due to wear, fatigue, stress or similar degradation in various portions of the valve train components.

There is therefore a need in the art for an improved intake and exhaust system for an internal combustion engine having a piston and cylinder. There is also a need in the art for an improved intake and exhaust system that reduces overall friction and resistance losses associated with conventional valve train components. There is also a need in the art for a simple and easily manufactured intake and exhaust system with fewer moving components that provides production cost savings, and simplifies assembly and maintenance procedures in comparison to conventional valve train systems. There is also a need in the art for an intake and exhaust system that eliminates conventional valve train poppet valves, springs and similar linear motion components which are susceptibility to a performance robbing condition known as “floating” or “valve float”. There is a further need in the art for an intake and exhaust system that may be easily adapted to existing internal combustion engines having pistons and cylinders without a significant redesign of the engine.

### SUMMARY OF THE INVENTION

In one aspect, there is disclosed a rotary intake and exhaust system for an internal combustion piston engine that includes an engine having at least one cylinder and piston that define a combustion chamber. A crankshaft is coupled to the piston for moving the piston within the cylinder. A cylinder head is positioned to interface with the combustion chamber and includes a combustion chamber transfer port, and bifurcated intake and exhaust passages, called ports or tracts, formed therein. A driven rotatable shaft is positioned in the cylinder head to interact with the combustion chamber transfer port. The shaft includes intake and exhaust ports wherein rotation of the shaft transfers fluids and gases in and out of the combustion chamber.

In another aspect, there is disclosed a rotary intake and exhaust system for an internal combustion piston engine that includes an engine having at least one cylinder and piston that define a combustion chamber. A crankshaft is coupled to the piston for moving the piston within the cylinder. A cylinder head is positioned to interface with the combustion chamber. The cylinder head includes a combustion chamber transfer port formed therein. The driven rotatable shaft is positioned in the cylinder head to interact with the combustion chamber transfer port. The shaft includes bores formed therein along a longitudinal axis of the shaft wherein one bore extends from a first end of the shaft to an intake manifold and another bore extends from a second end of the shaft to an exhaust manifold. Rotation of the shaft transfers fluids and gases into and out of the combustion chamber.

In a further aspect, there is disclosed a rotary intake and exhaust system for an internal combustion piston engine that includes an engine having at least one cylinder and piston that define a combustion chamber. A crankshaft is coupled to the piston for moving the piston within the cylinder. A cylinder head is positioned to interface with the combustion chamber. The cylinder head includes a combustion chamber transfer port, and bifurcated intake and exhaust passages, called ports or tracts, formed therein. A driven rotatable shaft is positioned in the cylinder head to interact with the combustion chamber transfer port. The shaft includes a first end having an intake portion formed thereon. The intake portion interfaces with the intake manifold and is connected to an intake port allowing transfer of a fluid or gas. A second end of the shaft includes an exhaust portion formed thereon. The exhaust portion interfaces with the exhaust manifold and is connected to an exhaust port allowing transfer of a fluid or gas. Rotation of the shaft transfers fluids and gases into and out of the combustion chamber.

### BRIEF DESCRIPTION OF THE DRAWINGS

FIG. 1 is a cutaway perspective view of a rotary intake and exhaust system for an internal combustion piston engine;

FIG. 2 is a perspective view of a rotary intake and exhaust system for an internal combustion piston engine detailing the intake and exhaust ports/tracts as well as the coupling of the crankshaft to the driven rotatable shaft;

FIG. 3 is a perspective view of one embodiment of a driven rotatable shaft;

FIG. 4 is a perspective view of a first or lower portion of a cylinder head;

FIG. 5 is a perspective view of a second or upper portion of a cylinder head;

FIG. 6 is a partial cutaway of the cylinder head of FIG. 4;

FIG. 7 is a partial cutaway view of the cylinder head of FIG. 4;

FIG. 8 is a graphical sectional view of a cylinder head and shaft coupling with the combustion chamber and also including side views of a bearing and seal;

FIG. 9 is a graphical depiction of movement of the shaft defining a four cycle combustion process;

FIG. 10 is a perspective view of a bearing and seal of a lower cylinder head;

FIG. 11 is a cutaway perspective view of a rotary intake and exhaust system for an internal combustion piston engine and an alternate shaft having a bore formed therein;

FIG. 12 is a perspective view of a rotary intake and exhaust system for an internal combustion piston engine detailing the intake and exhaust ports/tracts as well as the coupling of the crankshaft to the driven rotatable shaft and a shaft having a bore formed therein;

FIG. 13 is a perspective view of an embodiment of a shaft having a bore formed longitudinally from both ends;

FIG. 14 is a cutaway perspective view of the shaft of FIG. 13;

FIG. 15 is a perspective view of a first or lower portion of a cylinder head of FIG. 11;

FIG. 16 is a perspective view of a second or upper portion of a cylinder head of FIG. 11;

FIG. 17 is a partial cutaway view of the cylinder head of FIG. 15;

FIG. 18 is a cutaway perspective view of a rotary intake and exhaust system for an internal combustion piston engine and an alternate shaft including supercharging and turbo-charging structures;

FIG. 19 is a perspective view of a rotary intake and exhaust system for an internal combustion piston engine detailing the intake and exhaust ports/tracts as well as the coupling of the crankshaft to the driven rotatable shaft and a shaft having super-charging and turbo-charging structures;

FIG. 20 is perspective view of an embodiment of a driven rotatable shaft including supercharging and turbo-charging structures positioned in opposing bores of the shaft;

FIG. 21 is a cutaway view of the shaft of FIG. 20;

FIG. 22 is a cutaway view of the shaft of FIG. 20;

FIG. 23 is a cutaway view of the shaft of FIG. 20;

FIG. 24 is a partial perspective view of valve or waste gate.

### DETAILED DESCRIPTION OF THE PREFERRED EMBODIMENTS

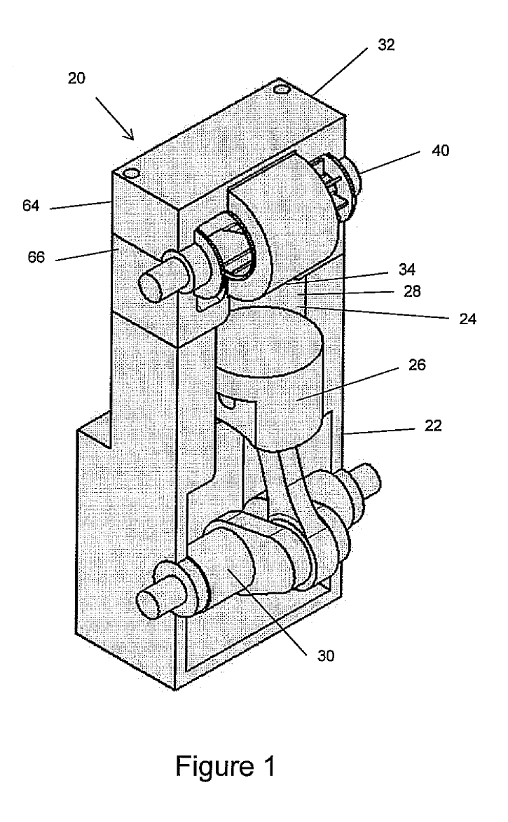

Referring to the various figures, there are shown various embodiments of a rotary intake and exhaust system 20 for an internal combustion piston engine. Referring to FIG. 1, there is shown a perspective view of the rotary intake and exhaust system 20. The system includes an engine 22 having at least one cylinder 24 and piston 26 that define a combustion chamber 28. A crankshaft 30 is coupled to the piston 26 for moving the piston 26 in the cylinder 24. A cylinder head 32 is positioned to interface with the combustion chamber 28. The cylinder head 32 includes a combustion chamber transfer port 34 and intake and exhaust ports/tracts 36, 38 formed therein. A driven rotatable shaft 40 is positioned in the cylinder head 32 to interact with the combustion chamber transfer port 34. The shaft 40 includes intake and exhaust ports 42, 44 wherein rotation of the shaft 40 transfers fluids and gases into and out of the combustion chamber 28.

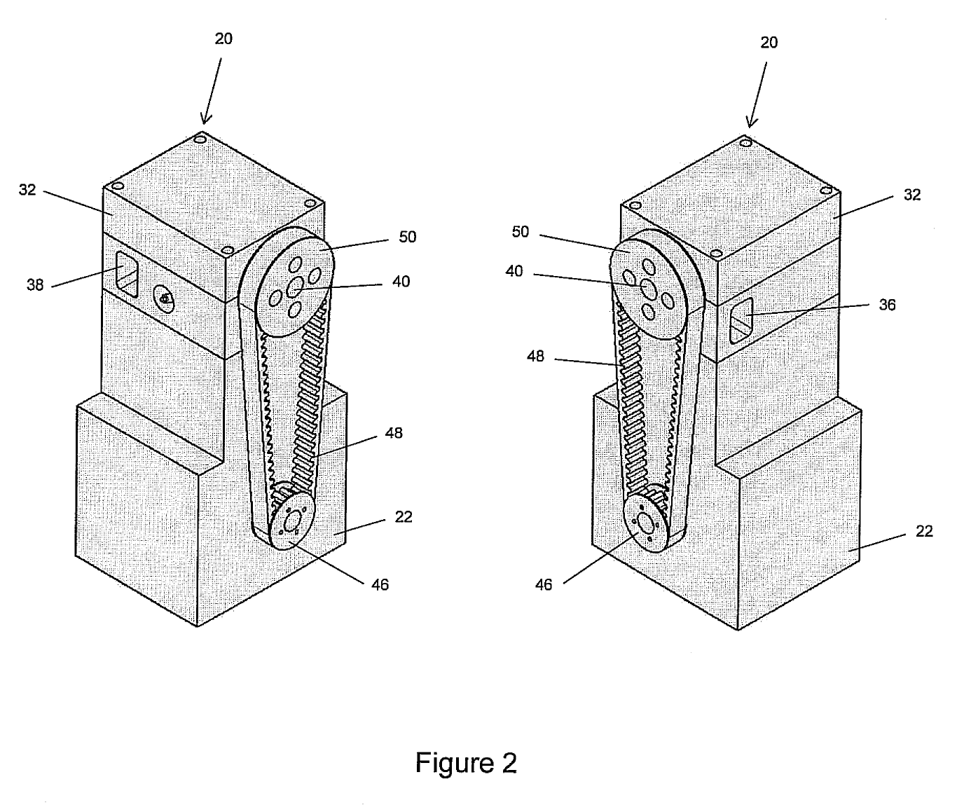

The perspective views of FIG. 2 detail the rotary intake and exhaust system 20 and engine 22 and show the intake and exhaust ports/tracts 36, 38 formed within the cylinder head 32. Also disclosed in FIG. 2 is a gear 46 that is linked to the crankshaft 30 and coupled with a belt 48 that drives the driven rotatable shaft 40 positioned within the cylinder head 32. In this manner, the crankshaft 30 rotation may be transferred to rotation of the driven rotatable shaft 40. In one aspect, a sprocket 50 is associated with the shaft 40 to engage the belt 48. The driven gear 46 from the crankshaft 30 and sprocket 50 are sized such that rotation of the crankshaft 30 may be timed with rotation of the driven shaft 40 to provide an intake and exhaust cycle for a four cycle engine. In one aspect, two crankshaft 30 rotations may be equal to one complete rotation of the driven shaft 40 within the cylinder head 32. In other words, a single cycle would be equal to a half crankshaft 30 rotation which is equal to a quarter rotation of the driven shaft 40 within the cylinder head 32.

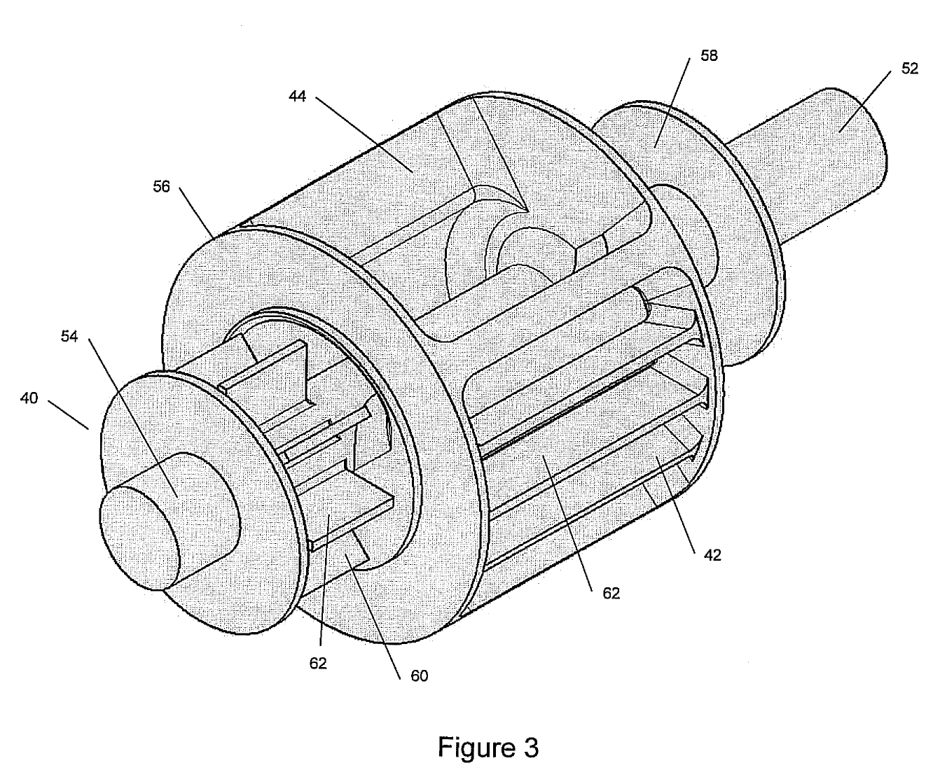

Referring to FIG. 3, there is shown one embodiment of a shaft 40 that includes a first end 52 separated longitudinally from a second end 54 by a body section 56. The first end 52 may include an intake portion 58 formed thereon. The intake portion 58 interfaces with the intake port 42 and the intake port/tract 36. The second end 54 of the shaft 40 includes an exhaust portion 60 formed thereon. The exhaust portion 60 interfaces with the exhaust port/tract 38 and exhaust port 44. The body section 56 positioned between the first and second ends 52, 54 includes the intake and exhaust ports 42, 44 formed thereon. In one aspect, the intake portion 58 is fluidly connected to the intake port 42 allowing transfer of a fluid or gas. Additionally, the exhaust portion 60 is fluidly connected to the exhaust port 44 allowing transfer of a fluid and gas. As can be seen in the figure, the intake port 42 may include vanes 62 formed thereon. Additionally, the exhaust portion 60 at the second end 54 may also include vanes 62 formed thereon. The vanes 62 may be utilized to drive a fluid or gas either into or out of the combustion chamber 28.

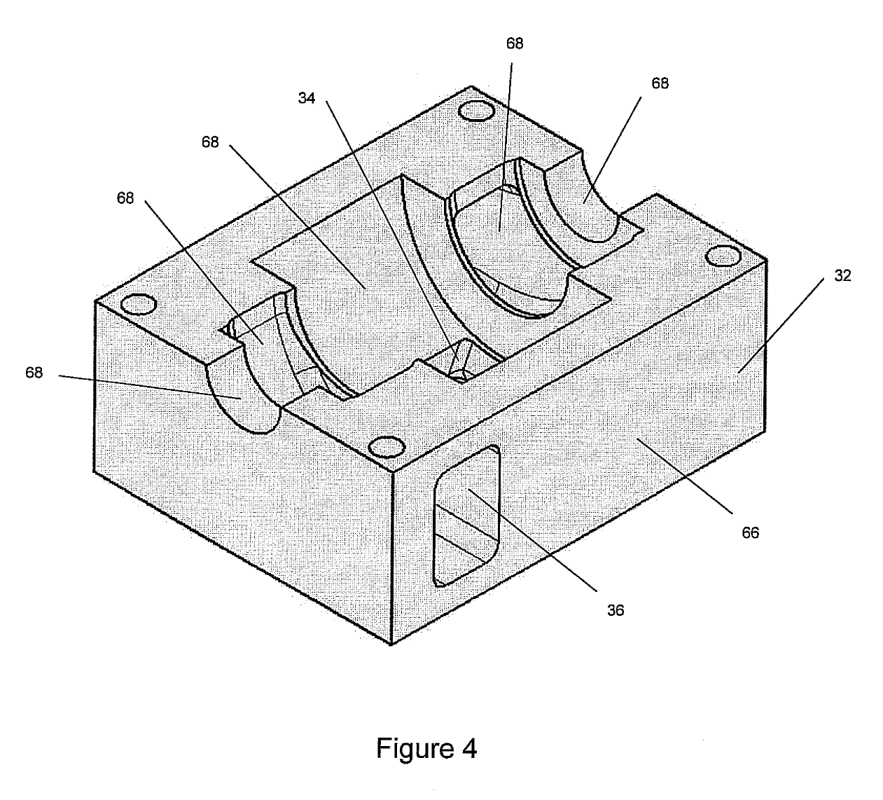

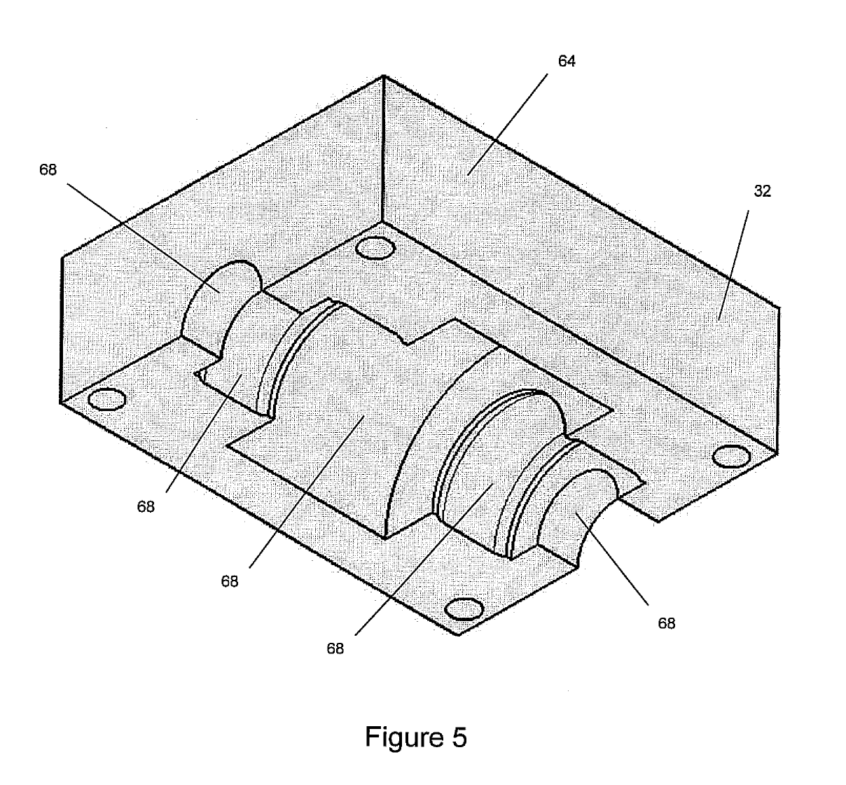

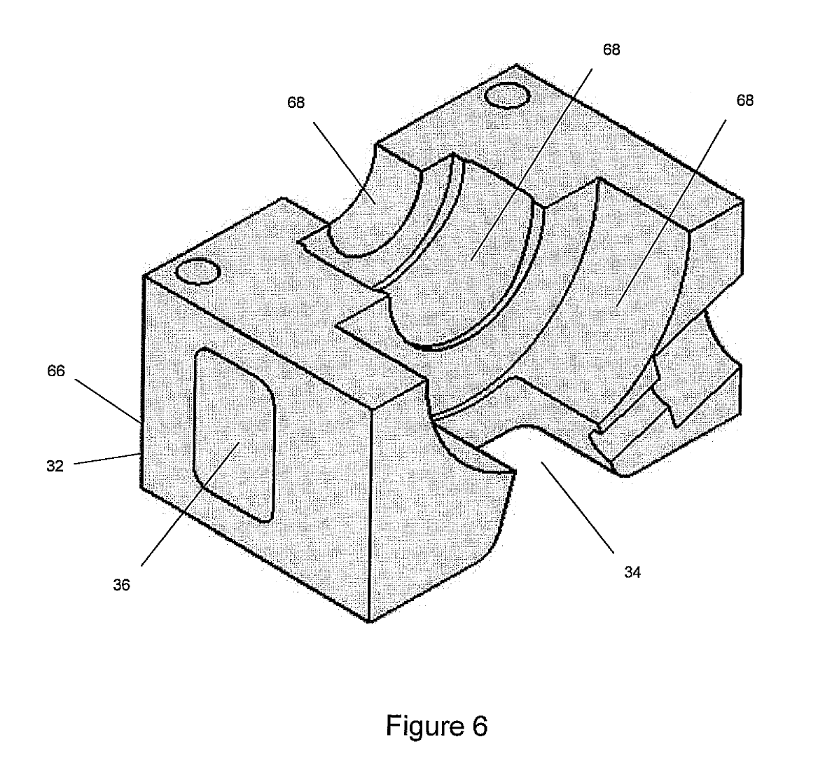

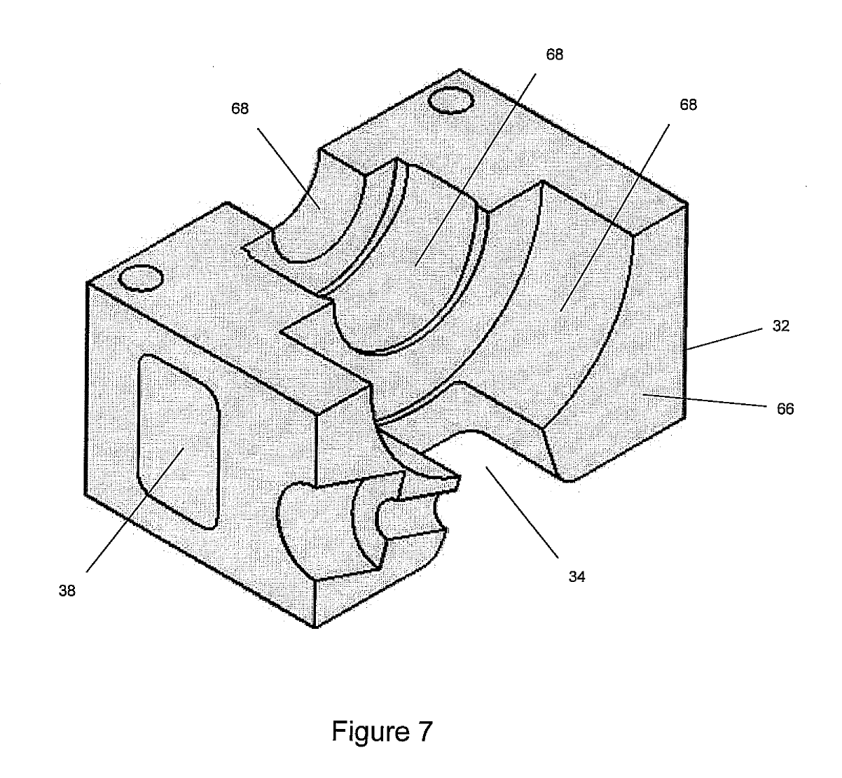

Referring to FIGS. 4-9, there are shown various portions of the cylinder head 32. In one aspect, the cylinder head 32 may include first and second portions or upper and lower portions 64, 66. Referring to FIG. 4, there is shown an embodiment of a lower portion 66 of the cylinder head 32. As can be seen in the figure, the lower portion 66 includes the intake and exhaust ports/tracts 36, 38 formed thereon. The lower portion 66 of the cylinder head 32 includes a series of bores or formations 68 that allow the shaft 40 to be journaled therein as well as allow transfer of a fluid or gas from the combustion chamber 28 through the combustion chamber transfer port 34. As can be seen in the figure, bores 68 are formed corresponding to the first and second ends 52, 54 of the shaft 40 and also include bores 68 corresponding to the intake and exhaust portions 58, 60 of the shaft 40. Additionally, a slot or bore 68 is formed within a central or body portion of the cylinder head 32 that corresponds with the body 56 of the shaft 40 that includes the intake and exhaust ports 42, 44 formed thereon. In this manner, the intake and exhaust ports 42, 44 of the shaft 40 are positioned to interact with the combustion chamber transfer port 34 allowing transfer of a fluid or gas into and out of the combustion chamber 28.

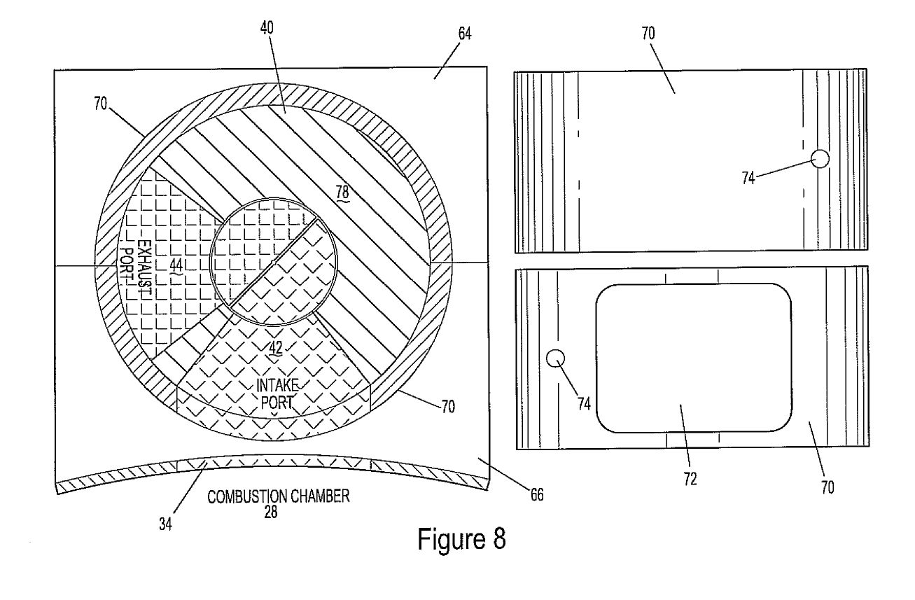

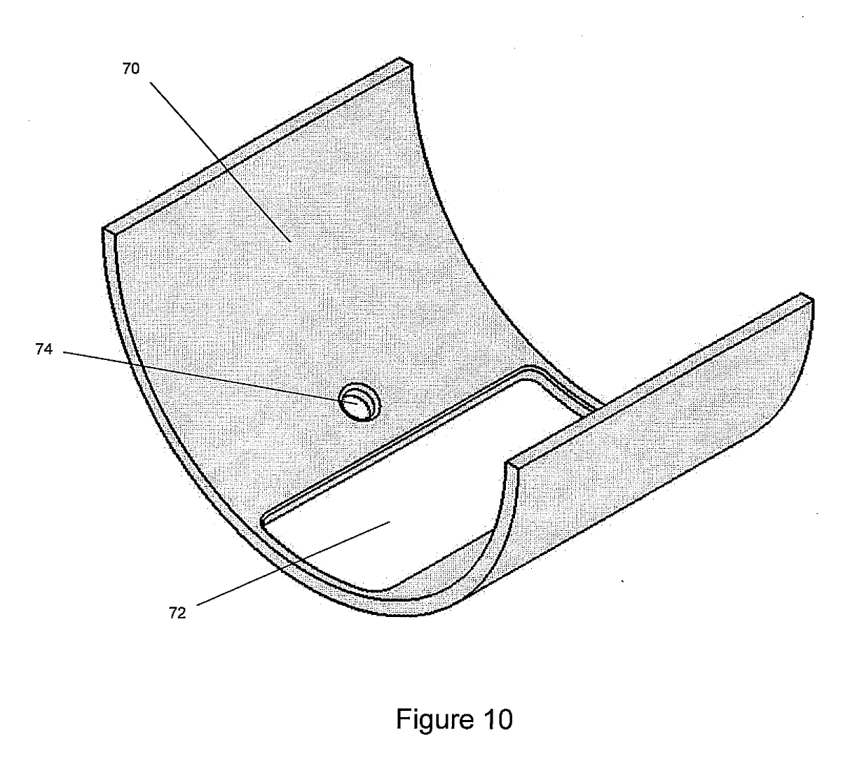

The second or upper portion 64 of the cylinder head 32 includes corresponding bores 68 and formations that match the formations on the lower portion 66. However, the intake and exhaust ports/tracts 36, 38 may extend only on the lower portion 66 of the cylinder head 32 on opposing sides of the cylinder head 32. In one aspect, a bearing and/or seal 70 are positioned in the cylinder head 32 sealing the shaft 40 relative to the cylinder head 32. In one aspect, as shown in FIGS. 8 and 10, the seal 70 may include a journal or other structure similar to bearings commonly utilized for camshafts, and between a crankshaft and a connecting rod. As can be seen in the figure, the seals 70 surround the driven rotatable shaft 40 and maintain the fluid or gases within the structure for transfer to the appropriate intake or exhaust port/tract 36, 38. It should be realized that various journals or bearings such as hybrid babbitt, plain, or journal bearings may be utilized. Additionally, as shown in the figure, the hybrid babbitt/plain/journal bearing may include an opening 72 formed thereon corresponding with the combustion chamber transfer port 34 and may also include a weep hole 74 to allow for lubrication of the various components of the intake and exhaust system. It should be realized that alternative seals or journals may be utilized. For example, apex and face seals may be installed to seal the shaft 40 and cylinder head 32 through the various cycles of the engine including the intake, compression, combustion, and exhaust cycles of a four stroke type engine.

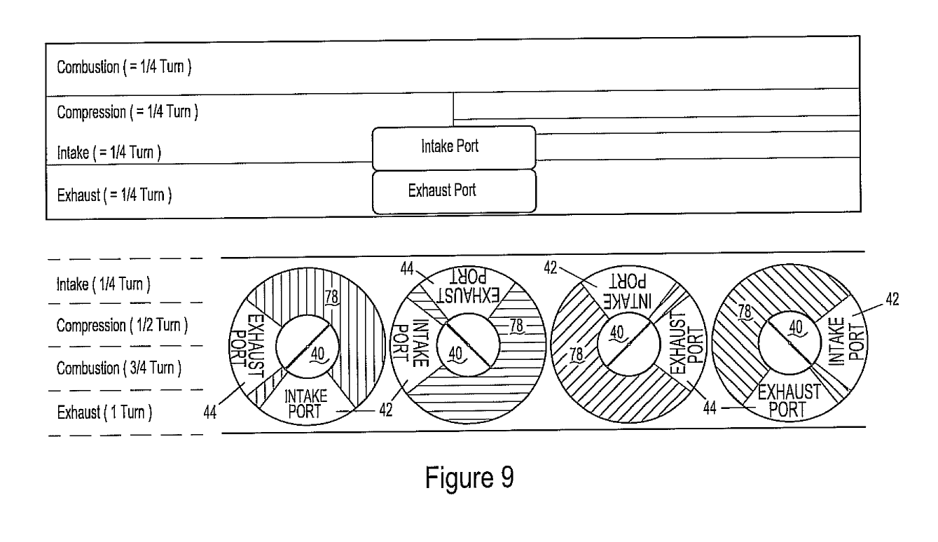

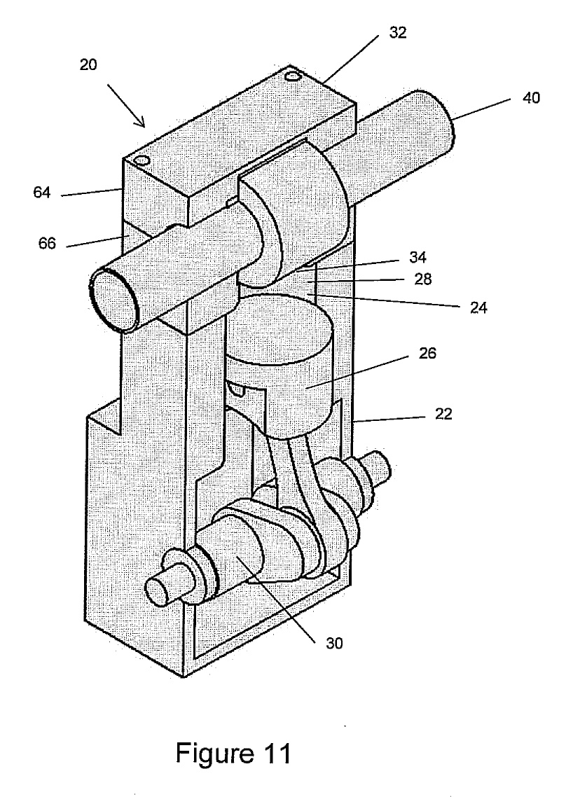

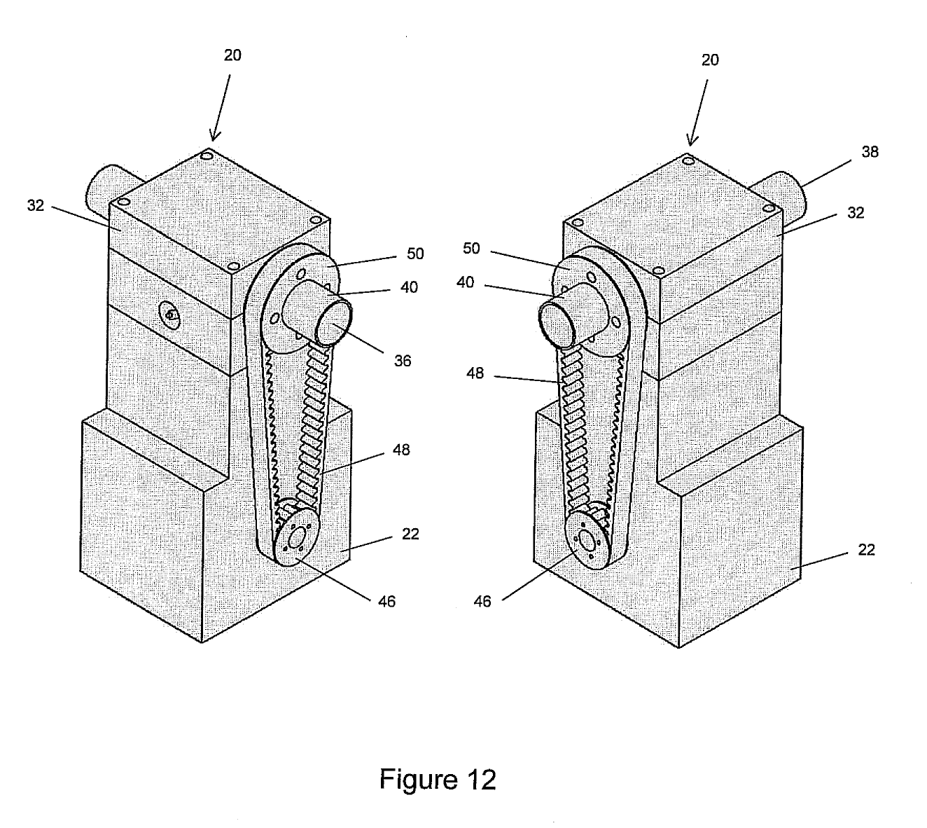

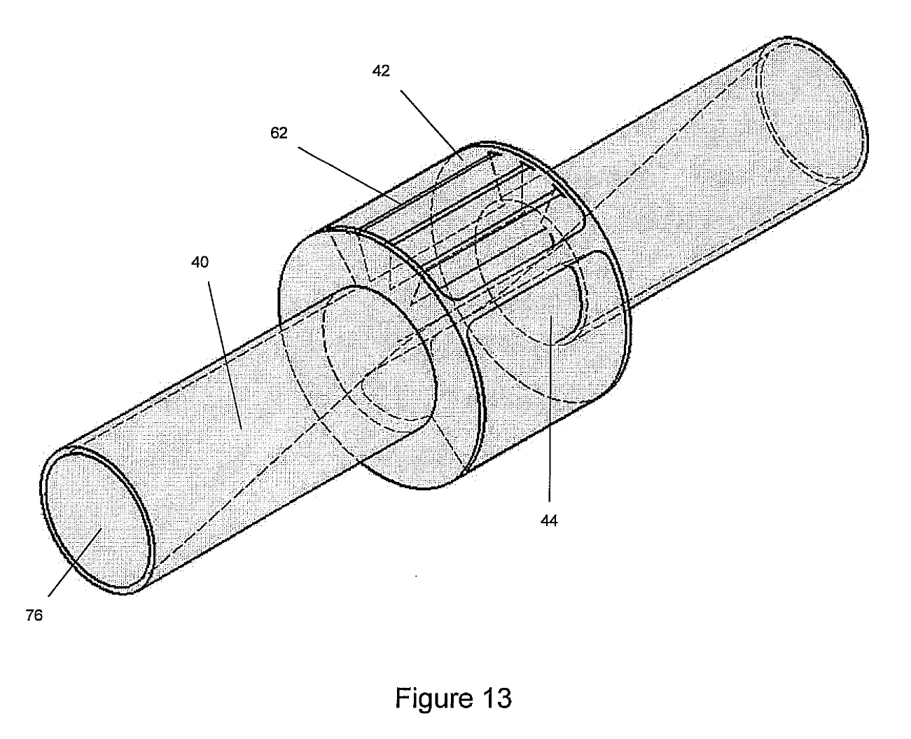

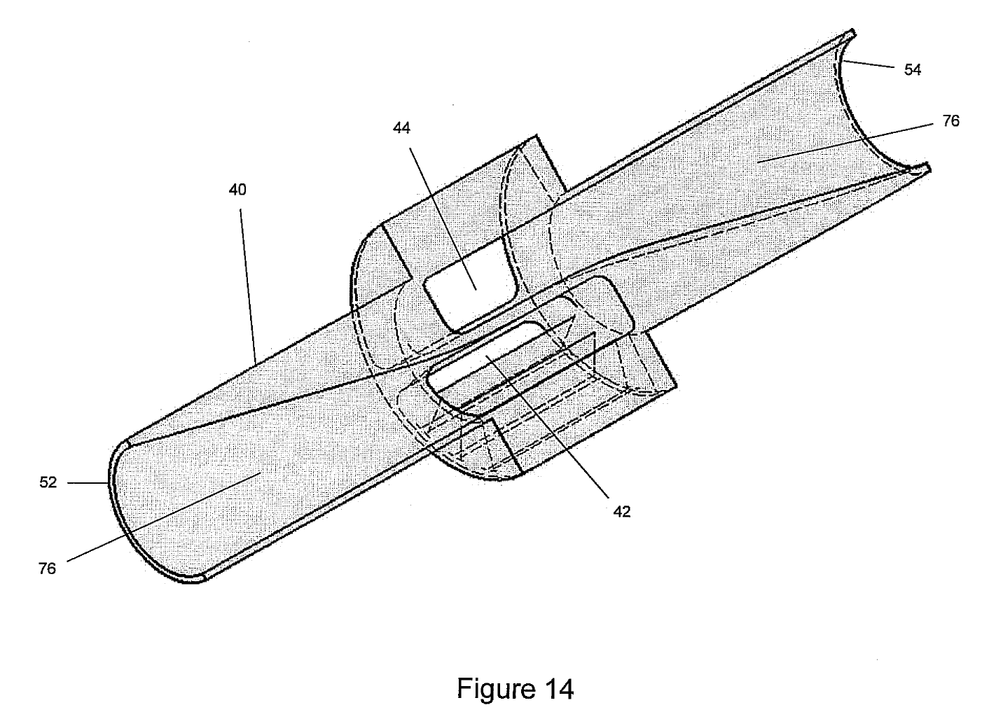

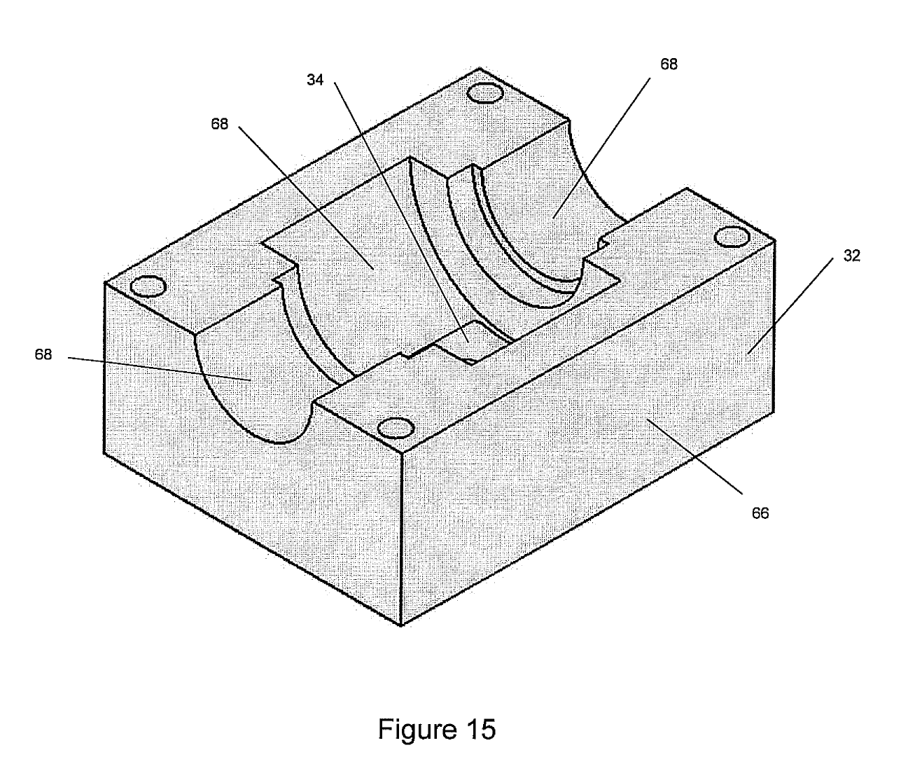

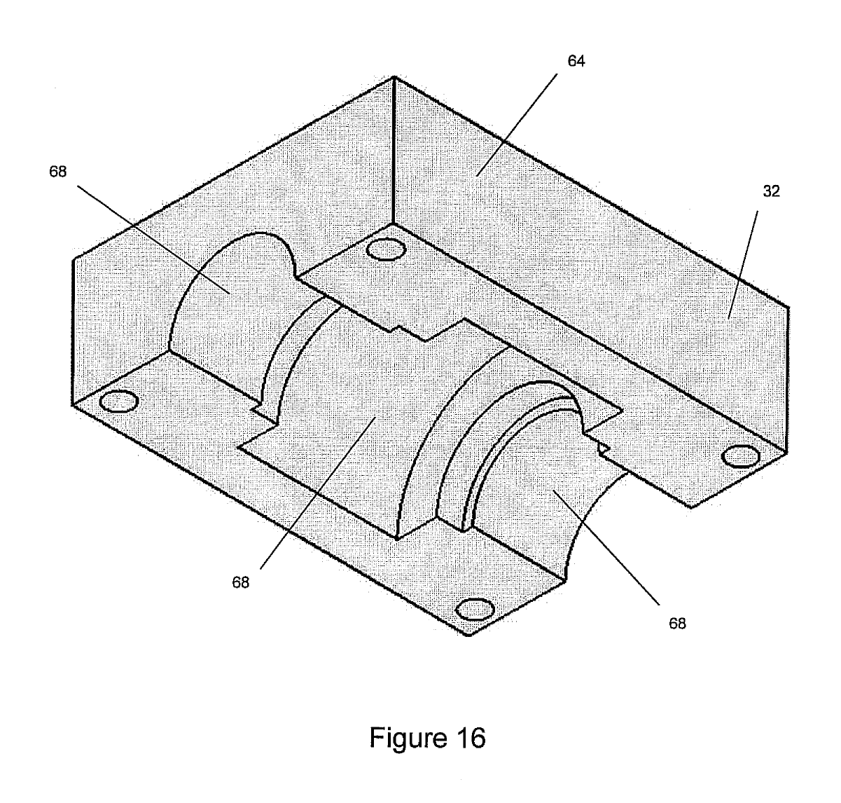

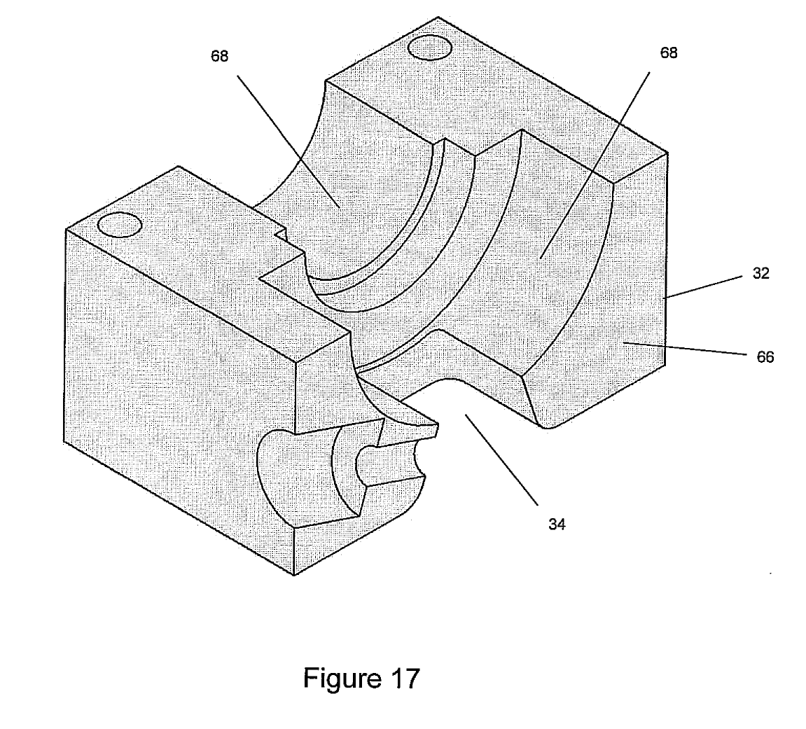

Referring to FIGS. 11-17, there is shown another embodiment of a shaft 40 that is driven and positioned within the cylinder head 32. In the depicted embodiment, the shaft 40 includes bores 76 formed therein along a longitudinal axis of the shaft 40. One of the bores 76 extends from a first end 52 of the shaft 40 to the intake port 42 and other bore 76 extends from a second end 54 of the shaft 40 to the exhaust port 44. In this manner, both the intake and exhaust ports 42, 44 are located within the same plane of rotation. As with the previously described shaft 40 embodiment, the intake port 42 may include vanes 62 formed thereon. A cylinder head associated with the second or alternative embodiment of the shaft need not have the bores 68 formed corresponding with the intake and exhaust portions detailed in FIGS. 4-7. An alternative cylinder head may include intake and exhaust ports/tracts defined by the opposing first and second ends 52, 54 of the driven shaft 40. Additionally, intake and exhaust manifolds may be attached to the cylinder head, positioned so to seal around intake and exhaust ports/tracts defined by the opposing first and second ends 52, 54 of the driven shaft 40, so to further direct fluids and gases into, out of, and away from the engine. As with the previously described cylinder head 32, a bore 68 may be positioned within a central region of the cylinder head 32 to accommodate the body 56 that includes the intake and exhaust ports 42, 44 of the shaft 40. Additionally, as with the previously described embodiment, the cylinder head 32 may include a combustion chamber transfer port 34 formed therein. Referring to FIG. 14, there is a cutaway view of the alternate embodiment of the shaft detailed in FIG. 13. As can be seen in FIG. 14, the bores 76 entering from the first and second ends 52, 54 of the shaft 40 may accommodate sections the shaft such that the intake and exhaust ports 42, 44 are radially spaced from each other on the shaft 40. In one aspect, the exhaust port 44 is radially spaced on the shaft 40 from the intake port 42 which is radially spaced from a compression and combustion section 78 of the shaft 40, as best seen in FIGS. 8 and 9.

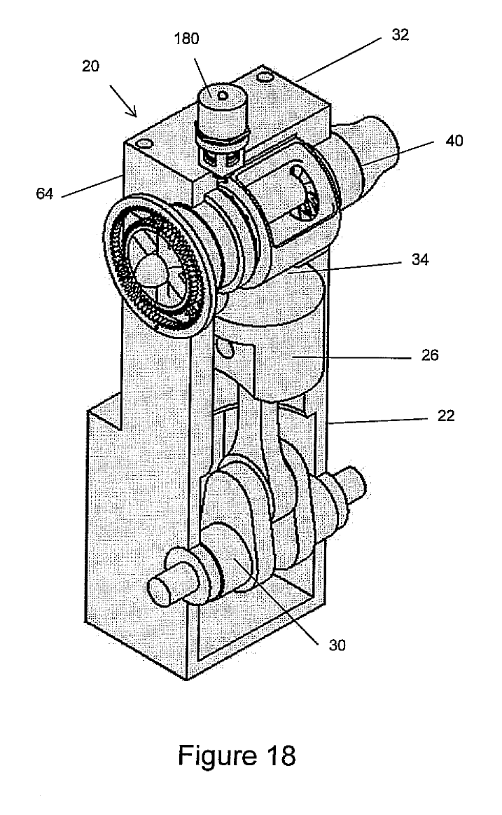

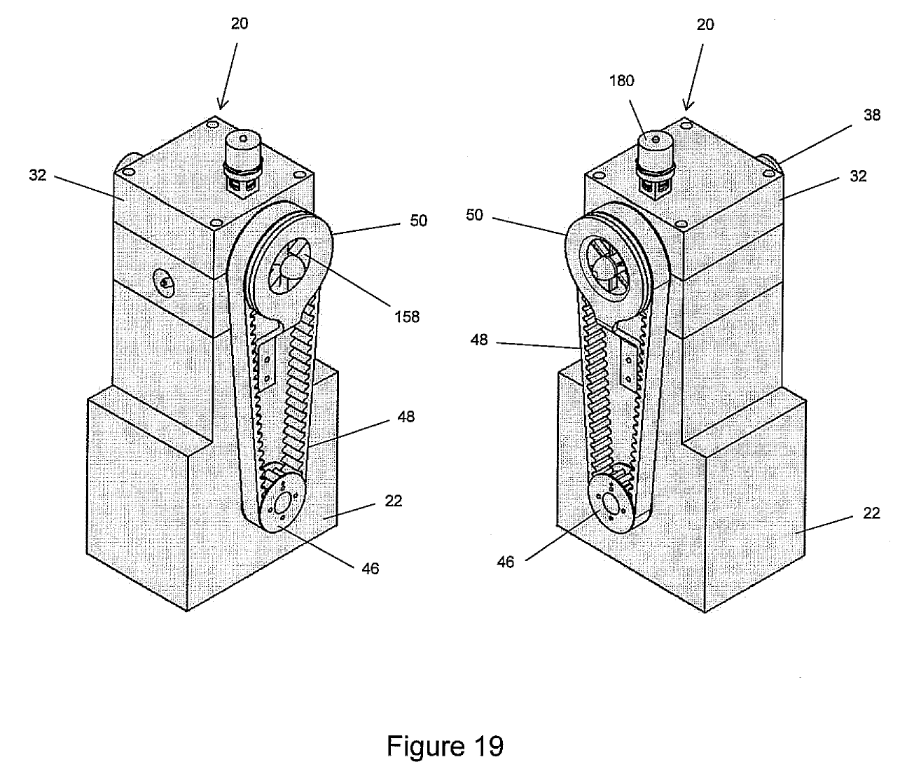

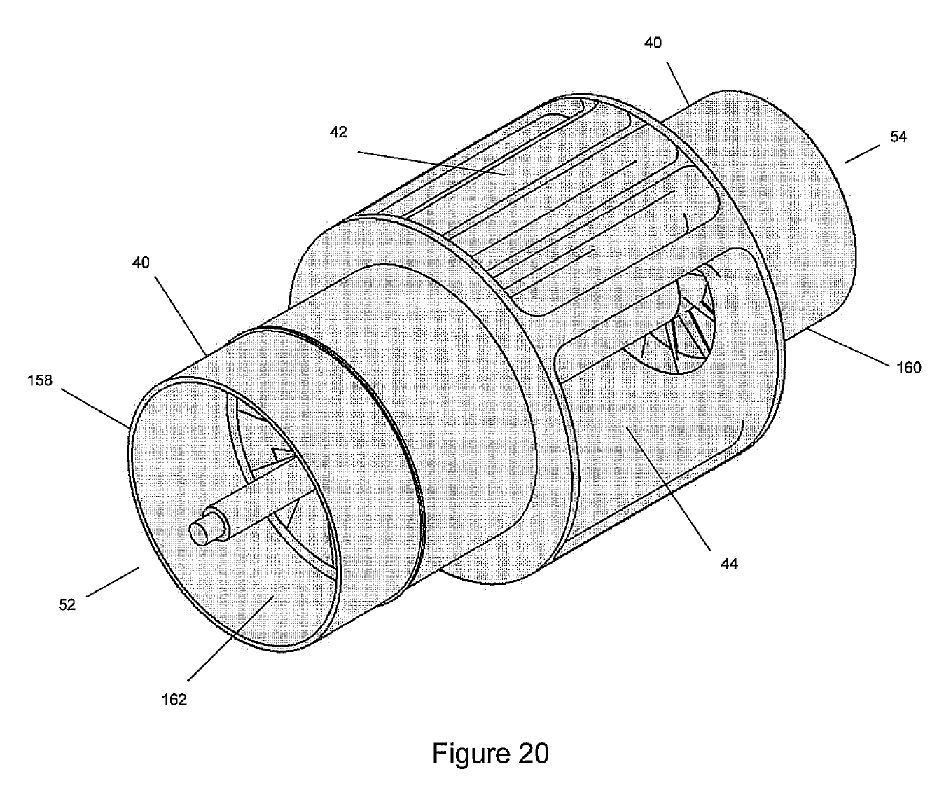

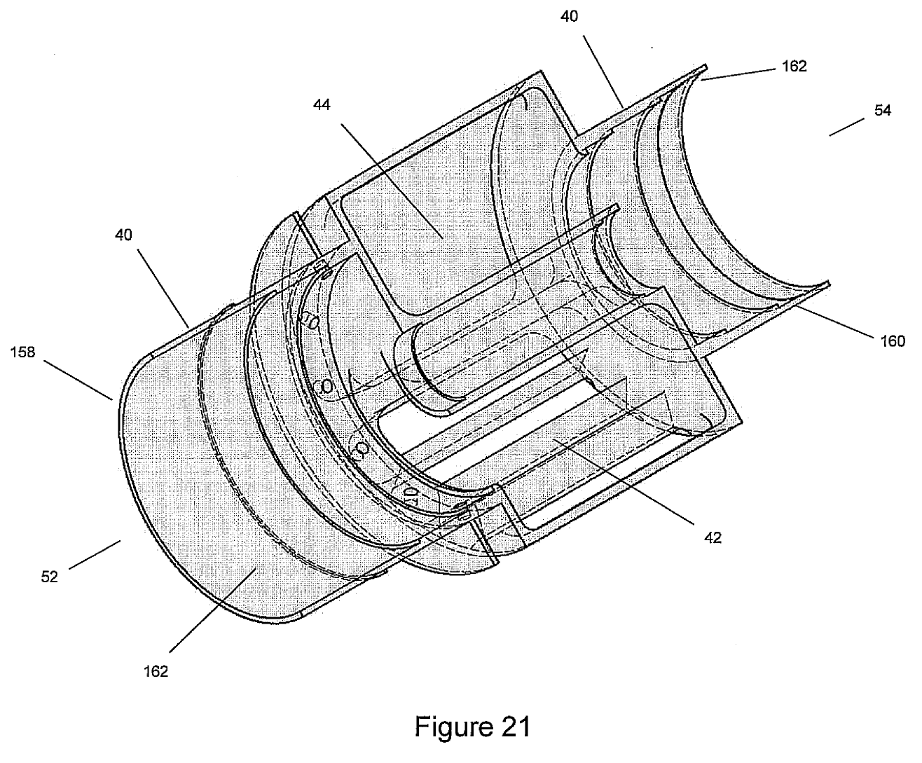

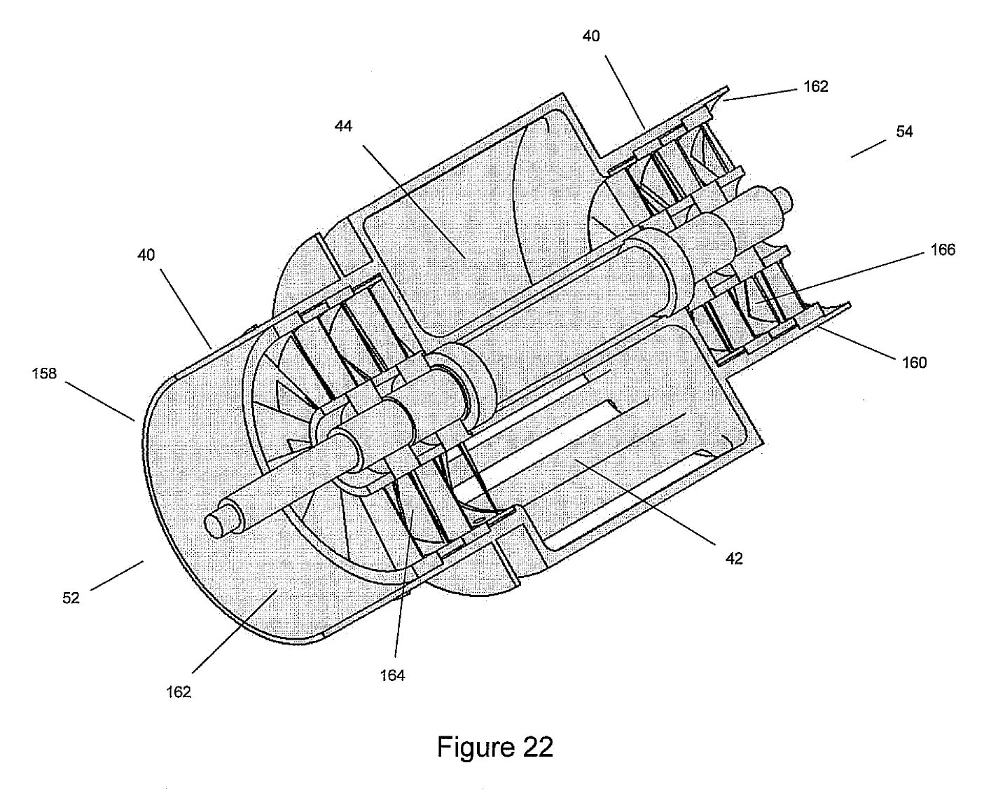

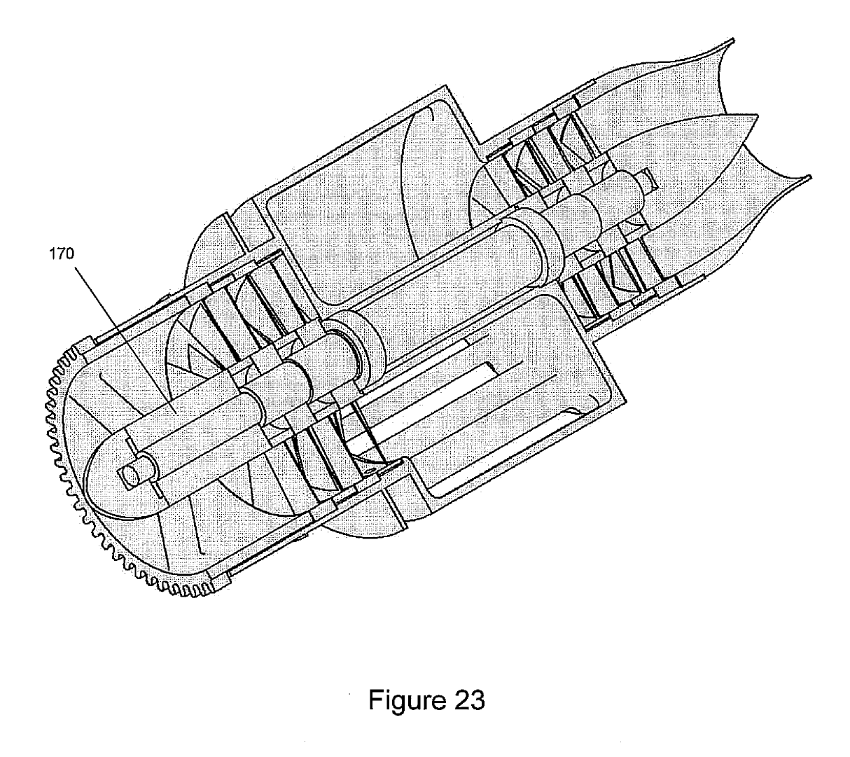

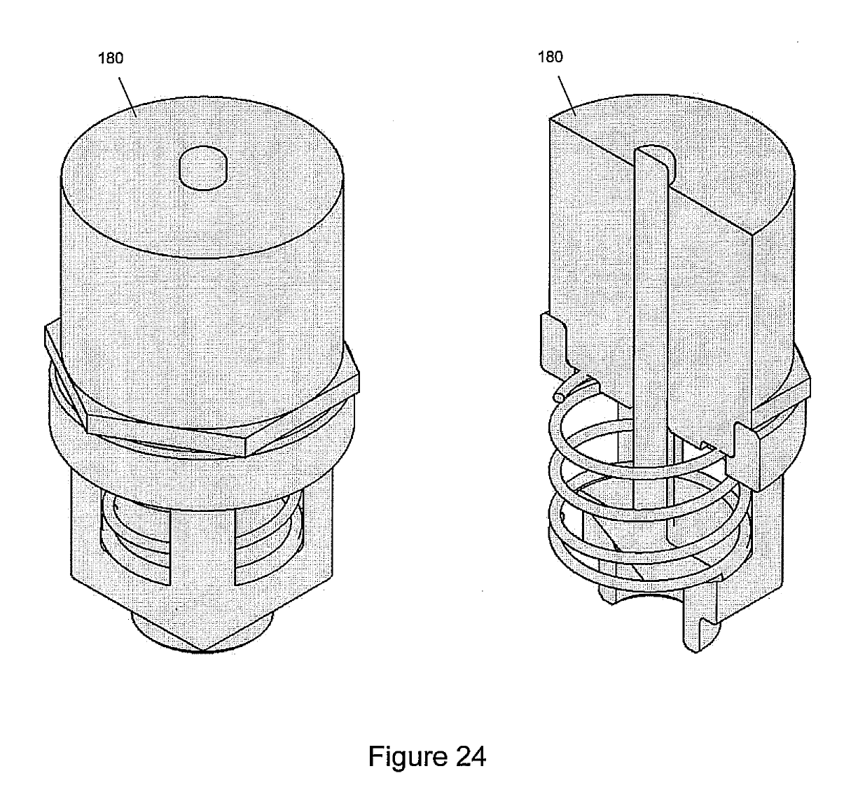

Referring to FIGS. 18-24, there is shown another alternative embodiment of a driven shaft 40. As can be seen in the figures, the shaft 40 includes an intake portion 158 formed on a first end 52 that interfaces with the intake port/tract 36. A second end 54 of the shaft 40 includes an exhaust portion 160 formed thereon that interfaces with the exhaust port/tract 38. In one aspect, the intake portion 158 includes a bore 162 formed therein that includes a supercharging structure 164 positioned within the bore 162 that is driven by the crankshaft. Additionally, the exhaust portion 160 includes a bore 162 formed therein that includes a turbo-charging structure 166 positioned within the bore 162 and is driven by an exhaust driven turbine. It should be realized that the shaft 40 may include one or the other or both of the turbo-charging and supercharging structures 164, 166 separately as opposed to both being positioned on the shaft as detailed in the figures. In this manner various structures may include the turbo-charging structure 166 on the exhaust 160 portion by itself, the supercharging structure 164 on the intake portion 158 by itself, or as detailed in the figure a combination of the supercharging and turbo-charging structures 164, 166. In one aspect, the supercharging and turbo-charging structures 164, 166 may be coupled to a common shaft that includes a clutch mechanism 170 and is driven by either the crankshaft or turbine at selected rotations per minute. In this manner, the supercharging structure 164 may be utilized at a lower rpm where the supercharger provides a greater benefit and the turbo-charging structure 166 may be utilized at higher rpm wherein the turbo-charging structure provides a higher benefit or increased horsepower to the engine. Referring to FIGS. 18, 19 and 24, there is shown a valve, wastegate or similar mechanism 180 positioned in the cylinder head 32 for regulating boost pressure. This mechanism can be automatically or manually controlled by mechanical, electrical, pneumatic, hydraulic or other means.

Referring to FIG. 9, the rotary intake and exhaust system 20 will be described with reference to a piston and cylinder engine having a four cycle combustion process. As can be seen in the figure, and as previously described above, the four cycle engine moves through the combustion process utilizing two crankshaft rotations that correspond to one rotation of the driven shaft 40. In other words, a single cycle is equal to half a crankshaft rotation which is equal to a quarter of the ported shaft rotation due to the gear and sprocket interface with the crankshaft. As can be seen in the figure, there is depicted a full rotation of the ported or driven shaft 40. In the first or leftmost part of the figure, the intake port 42 is presented on the first quarter turn relative to the combustion chamber transfer port 34 to allow air and fuel mixture to enter the combustion chamber 28. Next in the cycle is a compression section of the shaft 40 presented relative to the combustion chamber transfer port 34 corresponding to a half turn of the ported or driven shaft 40 wherein the fuel and air mixture is compressed prior to a spark or ignition. Following the compression cycle is the combustion cycle corresponding to a three-quarter turn of the ported or driven shaft 40 in which the spark ignites the fuel and air mixture. Following the combustion cycle is an exhaust cycle and which corresponds to a full turn of the ported or driven shaft 40 in which exhaust gases from the combustion chamber 28 may exit through the exhaust port 44 completing the fourth cycle of the engine. In this manner, the driven shaft 40 allows for intake and exhaust cycles as well as combustion and compression cycles without the use of springs or poppet valves currently utilized in internal combustion engines. The centrifugal forces applied by the rotary driven shaft 40 allow fuel and air to be intimately mixed and encourages greater atomization of the fuel within the cylinder and combustion chamber 28. Additionally, the rotary intake and exhaust system 20 may be utilized at higher rotations per minute in comparison to conventional valve trains and engines currently being utilized.

1. A rotary intake and exhaust system for an internal combustion piston engine comprising:
an engine including at least one cylinder and piston defining a combustion chamber;
a crankshaft coupled to the piston for moving the piston in the cylinder;
a cylinder head positioned to interface with the combustion chamber, the cylinder head including a combustion chamber transfer port, and bifurcated intake and exhaust passages, called ports or tracts, formed therein;
a driven rotatable shaft positioned in the cylinder head to interact with the combustion chamber transfer port, the shaft including intake and exhaust ports wherein rotation of the shaft transfers fluids and gases into and out of the combustion chamber.

2. The rotary intake and exhaust system of claim 1 wherein the cylinder head includes first and second portions.

3. The rotary intake and exhaust system of claim 1 including a seal positioned in the cylinder head sealing the shaft relative to the cylinder head.

4. The rotary intake and exhaust system of claim 1 wherein the seal includes first and second portions.

5. The rotary intake and exhaust system of claim 1 including a gear linked to the crankshaft and a belt coupled to the gear and engaging the shaft.

6. The rotary intake and exhaust system of claim 1 wherein the shaft includes a first end separated longitudinally from a second end by a body section.

7. The rotary intake and exhaust system of claim 6 wherein the first end includes an intake portion formed thereon, the intake portion interfacing with the intake manifold and the second end includes an exhaust portion formed thereon, the exhaust portion interfacing with the exhaust manifold.

8. The rotary intake and exhaust system of claim 7 wherein the body includes the intake and exhaust ports formed thereon.

9. The rotary intake and exhaust system of claim 8 wherein the intake portion is connected to the intake port allowing transfer of a fluid or gas.

10. The rotary intake and exhaust system of claim 8 wherein the exhaust portion is connected to the exhaust port allowing transfer of a fluid or gas.

11. The rotary intake and exhaust system of claim 7 wherein the intake port includes vanes formed thereon.

12. The rotary intake and exhaust system of claim 7 wherein the exhaust portion includes vanes formed thereon.

13. The rotary intake and exhaust system of claim 1 wherein the shaft includes bores formed therein along a longitudinal axis of the shaft.

14. The rotary intake and exhaust system of claim 13 wherein one bore extends from a first end of the shaft to the intake port and another bore extends from a second end of the shaft to the exhaust port.

15. The rotary intake and exhaust system of claim 14 wherein the intake port includes vanes formed thereon.

16. The rotary intake and exhaust system of claim 1 wherein the exhaust port is radially spaced on the shaft from the intake port which is radially spaced from a compression and combustion section.

17. The rotary intake and exhaust system of claim 6 wherein the first end includes an intake portion formed thereon, the intake portion interfacing with the intake manifold and the second end includes an exhaust portion formed thereon, the exhaust portion interfacing with the exhaust manifold.

18. The rotary intake and exhaust system 17 wherein the intake portion includes a bore formed therein including a supercharging structure positioned within the bore and driven by the crankshaft.

19. The rotary intake and exhaust system 17 wherein the exhaust portion includes a bore formed therein including a turbo-charging structure positioned within the bore and driven by an exhaust driven turbine.

20. The rotary intake and exhaust system 17 wherein the intake portion includes a bore formed therein including a supercharging structure positioned within the bore and driven by the crankshaft and the exhaust portion includes a bore formed therein including a turbo-charging structure positioned within the bore and driven by an exhaust driven turbine.

21. The rotary intake and exhaust system of claim 20 wherein the supercharging and turbo-charging structures are coupled to a common shaft that includes a clutch mechanism and is driven by either the crankshaft or turbine at selected rotations per minute.

22. A rotary intake and exhaust system for an internal combustion piston engine comprising:
an engine including at least one cylinder and piston defining a combustion chamber;
a crankshaft coupled to the piston for moving the piston in the cylinder;
a cylinder head positioned to interface with the combustion chamber, the cylinder head including a combustion chamber transfer port, and bifurcated intake and exhaust passages, called ports or tracts, formed therein;
a driven rotatable shaft positioned in the cylinder head to interact with the combustion chamber transfer port, the shaft including bores formed therein along a longitudinal axis of the shaft wherein one bore extends from a first end of the shaft to an intake port and another bore extends from a second end of the shaft to an exhaust port wherein rotation of the shaft transfers fluids and gases into and out of the combustion chamber.

23. A rotary intake and exhaust system for an internal combustion piston engine comprising:
an engine including at least one cylinder and piston defining a combustion chamber;
a crankshaft coupled to the piston for moving the piston in the cylinder;
a cylinder head positioned to interface with the combustion chamber, the cylinder head including a combustion chamber transfer port, and bifurcated intake and exhaust passages, called ports or tracts, formed therein;
a driven rotatable shaft positioned in the cylinder head to interact with the combustion chamber transfer port, the shaft including a first end having an intake portion formed thereon, the intake portion interfacing with the intake manifold and connected to an intake port allowing transfer of a fluid or gas and a second end includes an exhaust portion formed thereon, the exhaust portion interfacing with the exhaust manifold and connected to an exhaust port allowing transfer of a fluid or gas wherein rotation of the shaft transfers fluids and gases into and out of the combustion chamber.
